(19) United States
(12) Patent Application Publication
(10) Pub. No.: US 2025/0293327 A1
(43) Pub. Date: Sep. 18, 2025

(54) POWER STORAGE DEVICE

(71) Applicants: TOYOTA JIDOSHA KABUSHIKI KAISHA, Aichi-ken (JP); TOYOTA BATTERY CO., LTD., Shizuoka (JP)

(72) Inventors: Kazuhito KATO, Toyota-shi (JP); Yoshiro OBAYASHI, Toyota-shi (JP); Yosuke SHIMURA, Nagakute-shi (JP); Kenta MIYAHARA, Toyohashi-shi (JP); Takuya NOGUCHI, Toyota-shi (JP); Ryutaro SUZUKI, Hamamatsu-shi (JP); Yuji KATAYAMA, Okazaki-shi (JP); Masaya OGURA, Hamamatsu-shi (JP)

(21) Appl. No.: 19/057,974

(22) Filed: Feb. 20, 2025

(30) Foreign Application Priority Data
Mar. 14, 2024 (JP) 2024-039940

(51) Int. Cl. H01M 10/48; H01M 10/0587; H01M 10/54

(52) U.S. Cl. CPC H01M 10/488; H01M 10/0587; H01M 10/54

(57) ABSTRACT

A power storage device includes a power storage module including a plurality of power storage cells, and a case that accommodates the power storage module. Outer surfaces of the case are respectively provided with depressed portions, which indicate cut portions of the case to be cut when the power storage device is disassembled.

### CROSS REFERENCE TO RELATED APPLICATIONS

This nonprovisional application is based on Japanese Patent Application No. 2024-039940 filed on Mar. 14, 2024 with the Japan Patent Office, the entire contents of which are hereby incorporated by reference.

### BACKGROUND

### Field

The present disclosure relates to a power storage device.

### Description of the Background Art

Japanese National Patent Publication No. 2023-502457 discloses a battery including a housing and a plurality of electrode assembly sets. The plurality of electrode assembly sets are provided in the housing.

### SUMMARY

Although not explicitly described in Japanese National Patent Publication No. 2023-502457, the battery (power storage device) may be disassembled for recycling or the like. In this case, it is necessary to cut the battery at an appropriate position so as not to damage the electrode assembly set (power storage cell), for example. However, for example, an inexperienced worker or the like may need a long time to identify the appropriate position. In this case, it needs a long time to cut the battery at the appropriate position.

The present disclosure has been made to solve the above-described problem and an object of the present disclosure is to provide a power storage device that enables it to inhibit an increase in time needed to cut the power storage device at an appropriate position.

A power storage device according to an aspect of the present disclosure includes a power storage module including at least one power storage cell, and a case that accommodates the power storage module. An outer surface of the case is provided with an information providing portion indicating a cut portion of the case to be cut when the power storage device is disassembled.

In the power storage device according to the aspect of the present disclosure, as described above, the outer surface of the case is provided with the information providing portion indicating the cut portion of the case to be cut when the power storage device is disassembled. Thus, by setting the position appropriate for cutting the battery in advance as the cut portion, the case can be easily cut at an appropriate position on the basis of the information indicated by the information providing portion. As a result, it is enabled to inhibit an increase in time needed to cut the power storage device at the appropriate position.

In the power storage device according to the aspect, preferably, the at least one power storage cell includes a plurality of power storage cells. The power storage module includes a connection portion that connects different power storage cells of the plurality of power storage cells to each other. The cut portion corresponds to the connection portion. With this configuration, it is enabled to hinder the power storage cell from getting cut (damaged) since the portion of the case corresponding to the connection portion provided between the power storage cells is cut.

In the power storage device according to the aspect, preferably, the case has a sealed structure. When the case is sealed, it is difficult to visually check the inside of the case. Thus, providing the information providing portion indicating the cut portion of the case on the outer surface of the case is particularly effective in identifying the cut portion (the position appropriate for the cutting) of the case without visually checking the inside of the case.

In the power storage device according to the aspect, preferably, the cut portion includes a fragile portion. With this configuration, it is enabled to facilitate (simplify) the operation of cutting the case along the cut portion.

In the power storage device according to the aspect, preferably, the information providing portion includes at least one of a line and a mark given on the outer surface of the case to indicate the cut portion so that the cut portion is visually recognizable. With this configuration, the cut portion of the case can be easily identified on the basis of the at least one of the line and the mark.

In the power storage device according to the aspect, preferably, the information providing portion includes at least one of a depressed portion and a projecting portion formed on the outer surface of the case to indicate the cut portion so that the cut portion is visually recognizable. With this configuration, the cut portion of the case can be easily identified on the basis of the at least one of the depressed portion and the projecting portion.

In the power storage device according to the aspect, preferably, the information providing portion includes a member attached to the outer surface of the case to indicate the cut portion so that the cut portion is visually recognizable. With this configuration, the cut portion of the case can be easily identified on the basis of the member attached to the outer surface of the case.

In the power storage device according to the aspect, preferably, the information providing portion includes a code, information on the cut portion being obtainable from the code imaged by an information obtaining device. With this configuration, the cut portion of the case can be easily identified on the basis of the information obtained through the imaging of the code.

The foregoing and other objects, features, aspects, and advantages of the present disclosure will become apparent from the following detailed description of the present disclosure, which will be understood in conjunction with the accompanying drawings.

### BRIEF DESCRIPTION OF THE DRAWINGS

FIG. 1 is a perspective view illustrating a configuration of a power storage device according to an embodiment.

FIG. 2 is a partial perspective view illustrating, on an enlarged scale, a configuration of a case and a power storage module according to the embodiment.

FIG. 3 is a schematic plan view illustrating an arrangement of a plurality of power storage cells according to the embodiment.

FIG. 4 is an exploded perspective view illustrating a configuration of the power storage cell according to the embodiment.

FIG. 5 is a side view illustrating, from the Y1 side, the configuration of the power storage device according to the embodiment.

FIG. 6 is a side view illustrating, from the X1 side, the configuration of the power storage device according to the embodiment.

FIG. 7 is a cross-sectional view along line VII-VII in FIG. 5.

FIG. 8 is a cross-sectional view along line VIII-VIII in FIG. 6.

FIG. 9 is a cross-sectional view along line IX-IX in FIG. 5.

FIG. 10 is a side view illustrating a configuration of a power storage device according to a first variation of the embodiment.

FIG. 11 is a partial cross-sectional view illustrating, on an enlarged scale, a projecting portion provided on a case according to a second variation of the embodiment.

FIG. 12 is a side view illustrating a configuration of a power storage device according to a third variation of the embodiment.

FIG. 13 is a perspective view illustrating a configuration of a power storage device according to a fourth variation of the embodiment.

### DESCRIPTION OF THE PREFERRED EMBODIMENTS

Embodiments of the present disclosure are described with reference to the drawings. In the drawings referred to below, the same reference numerals are given to identical or equivalent members.

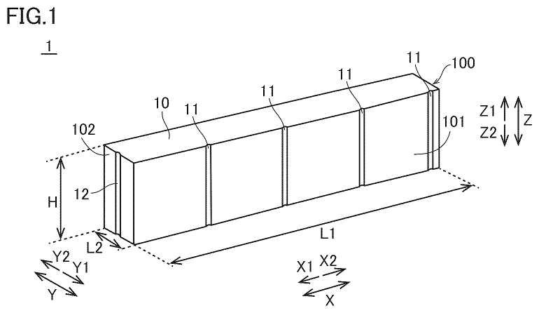

FIG. 1 is a perspective view that schematically illustrates a power storage device 1 according to an embodiment of the present disclosure. Power storage device 1 stores power for driving an electrically powered vehicle (not illustrated), for example. Power storage device 1 may be provided in an electric device other than the electrically powered vehicle (such as a stationary power storage device). An X direction, a Y direction, and a Z direction in the present specification are orthogonal to each other. For example, the X direction and the Y direction may be the front-rear direction and the left-right direction of the electrically powered vehicle, respectively. The Z direction may be the vertical direction.

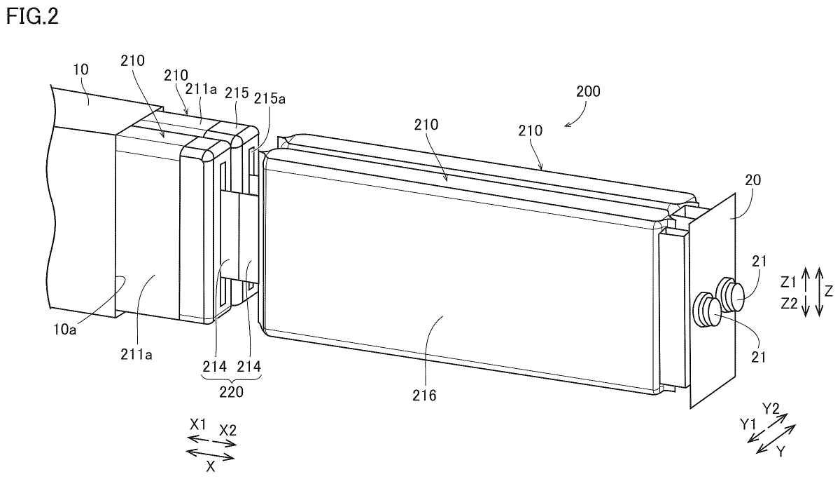

As illustrated in FIGS. 1 and 2, power storage device 1 includes a case 100 and a power storage module 200 (see FIG. 2). Case 100 is made of, for example, aluminum.

Referring to FIG. 1, case 100 is formed in a rectangular parallelepiped shape. Case 100 is formed in the rectangular parallelepiped shape, which is long in the X direction. Specifically, case 100 has a dimension L1 in the X direction. Case 100 has a dimension L2 in the Y direction. Dimension L1 is larger than dimension L2. Case 100 has a height H in the Z direction. Height H is smaller than dimension L1. Height H is larger than dimension L2. The shape of case 100 (the large-small relation among the respective dimensions in the directions) is not limited to the above-described example.

Referring to FIG. 2, case 100 includes a case body 10 and a lid 20. Case body 10 is formed in a rectangular tube shape long in the X direction. Lid 20 is connected to case body 10 by welding or the like so as to close an opening 10a on the X2 side of case body 10. Case body 10 is not provided with an opening other than opening 10a. That is, case 100 has a sealed structure. Power storage module 200 is inserted into case body 10 through opening 10a. In FIG. 2, a depressed portion 11, described later, is not illustrated for simplification.

Power storage module 200 includes a plurality of power storage cells 210. In the present embodiment, the number of power storage cells 210 is eight. However, the number of power storage cells 210 is not limited to eight. Examples of each power storage cell 210 include a lithium ion battery. Each power storage cell 210 may be composed of a so-called all-solid-state battery that includes a solid electrolyte. Each of the plurality of power storage cells 210 has a shape extending so as to be longer in the X direction than in the Y direction and longer in the X direction than in the Z direction. Each of the plurality of power storage cells 210 has a shape extending so as to be longer in the Z direction than in the Y direction.

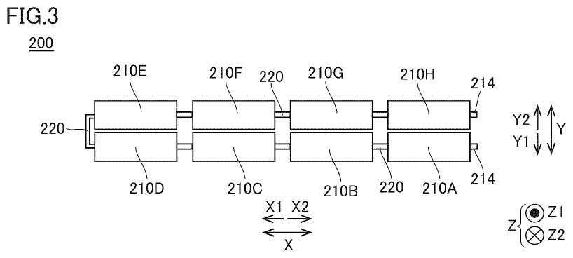

As illustrated in FIG. 3, the eight power storage cells 210 are electrically connected in series. The eight power storage cells 210 include a power storage cell 210A, a power storage cell 210B, a power storage cell 210C, a power storage cell 210D, a power storage cell 210E, a power storage cell 210F, a power storage cell 210G, and a power storage cell 210H. Power storage cells 210A to 210D are arranged in the X direction. Specifically, power storage cell 210A, power storage cell 210B, power storage cell 210C, and power storage cell 210D are arranged in this order from the X2 side. Power storage cells 210E to 210H are arranged in the X direction.

Specifically, power storage cell 210E, power storage cell 210F, power storage cell 210G, and power storage cell 210H are arranged in this order from the X1 side.

The row of power storage cells 210A to 210D and the row of power storage cells 210E to 210H are adjacent to each other in the Y direction. Specifically, power storage cell 210A and power storage cell 210H are adjacent to each other in the Y direction. Power storage cell 210B and power storage cell 210G are adjacent to each other in the Y direction. Power storage cell 210C and power storage cell 210F are adjacent to each other in the Y direction. Power storage cell 210D and power storage cell 210E are adjacent to each other in the Y direction.

Power storage cell 210A and power storage cell 210B are electrically connected by a connection portion 220. Power storage cell 210B and power storage cell 210C are electrically connected by connection portion 220. Power storage cell 210C and power storage cell 210D are electrically connected by connection portion 220. Power storage cell 210D and power storage cell 210E are electrically connected by connection portion 220. Power storage cell 210E and power storage cell 210F are electrically connected by connection portion 220. Power storage cell 210F and power storage cell 210G are electrically connected by connection portion 220. Power storage cell 210G and power storage cell 210H are electrically connected by connection portion 220. Connection portion 220 that electrically connects power storage cell 210D and power storage cell 210E is bent in a U-shape. Each of the plurality of connection portions 220 other than connection portion 220 between power storage cell 210D and power storage cell 210E is formed in a linear shape.

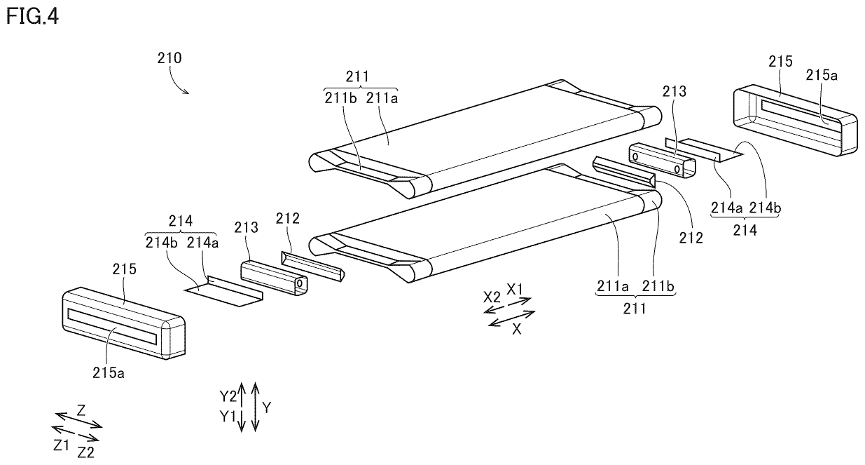

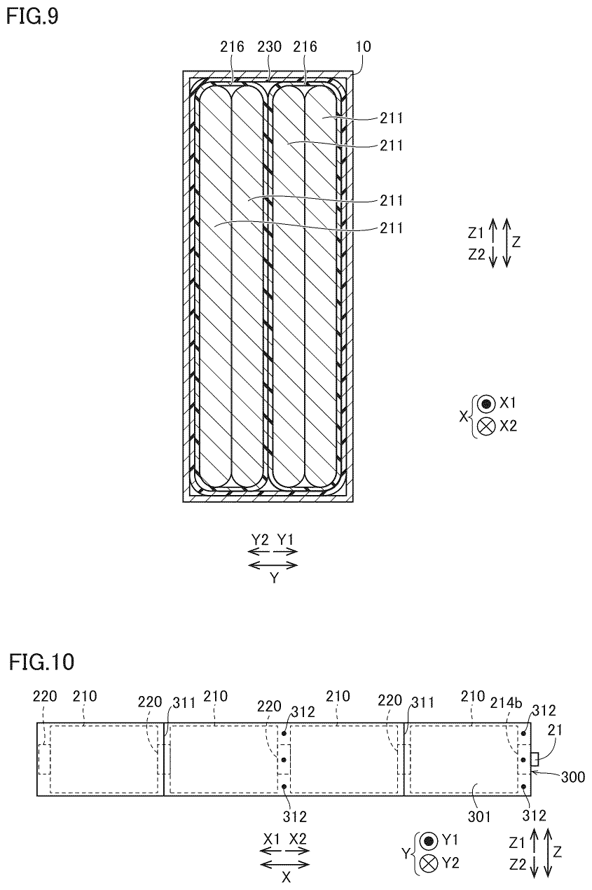

FIG. 4 is an exploded perspective view of power storage cell 210. Each power storage cell 210 includes at least one electrode assembly 211, a spacer 212, a terminal member 213, a current collector terminal 214, a cover 215, and a laminate exterior package 216 (see FIG. 9 for example). In FIG. 4, laminate exterior package 216 is not illustrated. Further, in FIG. 2, laminate exterior package 216 of power storage cell 210B (see FIG. 3) and laminate exterior package 216 of power storage cell 210G (see FIG. 3) are not illustrated.

The at least one electrode assembly 211 includes two electrode assemblies 211. However, the number of electrode assemblies 211 is not limited to two. Each electrode assembly 211 is formed by a wound body in which a positive electrode sheet and a negative electrode sheet are wound with a separator interposed therebetween. However, each electrode assembly 211 may be formed by a stack in which a positive electrode sheet and a negative electrode sheet are stacked with a separator interposed therebetween. The two electrode assemblies 211 are adjacent to each other in the Y direction in which the positive electrode sheet and the negative electrode sheet are mutually stacked. Each electrode assembly 211 is formed in a shape long in the X direction.

Each electrode assembly 211 includes a coated portion 211a and an electrode tab 211b. Coated portion 211a is a region of an electrode foil in the positive electrode sheet or the negative electrode sheet where an active material layer is provided. Electrode tab 211b is a region of the electrode foil in the positive electrode sheet or the negative electrode sheet where the active material layer is not provided (i.e. an uncoated portion where the electrode foil is exposed).

Spacer 212 is disposed between a pair of electrode tabs 211b adjacent to each other. Spacer 212 is made of an electrically insulating material (such as a synthetic resin). Spacer 212 has a shape in which the dimension in the Y direction gradually becomes larger with an increase in the distance from coated portion 211a in the X direction.

Terminal member 213 is connected to an outer side surface of spacer 212 in the X direction. Terminal member 213 is made of a conductive material (metal such as copper or aluminum). Terminal member 213 is connected to the pair of electrode tabs 211b adjacent to each other in the Y direction.

Current collector terminal 214 is connected to terminal member 213. Current collector terminal 214 electrically connected, via terminal member 213, to electrode tab 211b as a positive electrode tab is made of aluminum for example. Current collector terminal 214 electrically connected, via terminal member 213, to electrode tab 211b as a negative electrode tab is made of copper for example. Current collector terminal 214 includes a connection portion 214a and a protruding portion 214b.

Connection portion 214a is connected to an outer side surface of terminal member 213 in the X direction by welding or the like. Connection portion 214a is formed in a flat plate shape.

Protruding portion 214b protrudes outward in the X direction from connection portion 214a. Protruding portion 214b is formed in a flat plate shape. Power storage cells 210 electrically connected to each other are electrically connected by connecting their respective protruding portions 214b to each other. Protruding portions 214b electrically connected to each other form connection portion 220 (see FIG. 3).

Cover 215 covers an end portion (electrode tab 211b) of electrode assembly 211 in the X direction. Cover 215 is made of an electrically insulating material (such as a synthetic resin). Cover 215 is provided with a through hole 215a through which protruding portion 214b is inserted.

Laminate exterior package 216 accommodates each electrode assembly 211, spacer 212, terminal member 213, part of current collector terminal 214, and cover 215. Laminate exterior package 216 is formed by a laminate film.

An external terminal 21 (see FIG. 2) is provided on lid 20. External terminals 21 are electrically connected to current collector terminals 214 on the X2 side of power storage cells 210 (power storage cells 210A and 210H) positioned closest to lid 20 among the plurality of power storage cells 210.

The power storage device may be disassembled for recycling or the like. In this case, it is necessary to cut the power storage device at an appropriate position so as not to damage the power storage cell for example. However, for example, an inexperienced worker or the like may need a long time to identify the appropriate position. In this case, it needs a long time to cut the power storage device at the appropriate position.

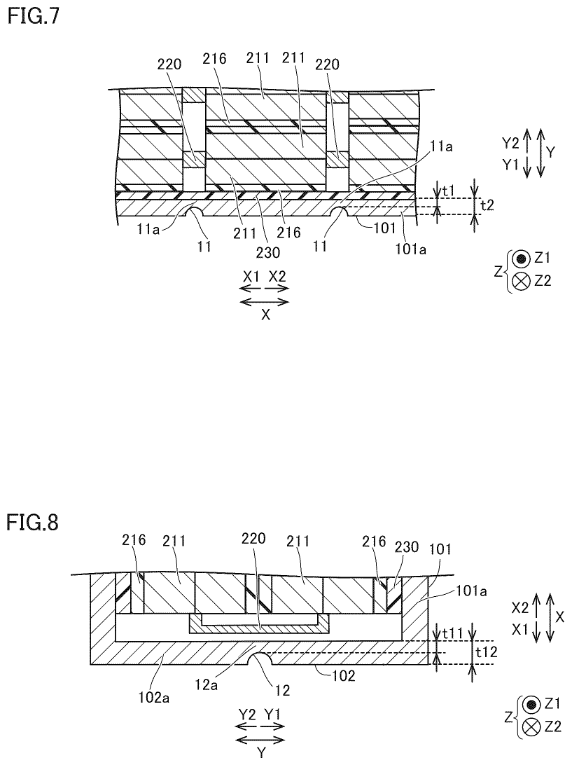

Thus, in the present embodiment, as illustrated in FIG. 1, depressed portion 11 indicating a cut portion of case 100 to be cut when power storage device 1 is disassembled is provided on an outer surface 101 of case 100. The cut portion of case 100 is indicated by depressed portion 11 so as to be visually recognizable. Outer surface 101 is, for example, an outer surface provided on a side surface 101a on the Y1 side, which is included in the pair of side surfaces 101a (see FIG. 7) orthogonal to the Y direction. The plurality of (four in the present embodiment) depressed portions 11 are provided on outer surface 101. The plurality of depressed portions 11 are provided side by side in the X direction. By cutting power storage device 1 along depressed portion 11, power storage cells 210 arranged in the X direction are separated from each other. In addition, power storage cells 210 arranged in the X direction and external terminal 21 are separated from each other. Cutting power storage device 1 along depressed portion 11 means cutting power storage device 1 at the position in the X direction where depressed portion 11 is provided. Depressed portion 11 is an example of the “information providing portion” in the present disclosure.

Depressed portion 11 is provided so as to extend in the Z direction on outer surface 101. That is, a groove extending in the Z direction is formed by depressed portion 11 on outer surface 101. Specifically, depressed portion 11 extends from an end portion of outer surface 101 on the Z1 side to an end portion of outer surface 101 on the Z2 side. The shape, length, and the like of depressed portion 11 are not limited to the above-described example.

An outer surface 102 of case 100 is provided with a depressed portion 12 indicating the cut portion of case 100 to be cut when power storage device 1 is disassembled. Outer surface 102 is, for example, an outer surface provided on a side surface 102a on the X1 side, which is included in the pair of side surfaces 102a (see FIG. 8) orthogonal to the X direction. Only one depressed portion 12 is provided on outer surface 102. By cutting power storage device 1 along depressed portion 12, power storage cells 210 adjacent to each other in the Y direction are separated from each other. Cutting power storage device 1 along depressed portion 12 means cutting power storage device 1 at the position in the Y direction where depressed portion 12 is provided. Depressed portion 12 is an example of the “information providing portion” in the present disclosure.

Depressed portion 12 is provided so as to extend in the Z direction on outer surface 102. That is, a groove extending in the Z direction is formed by depressed portion 12 on outer surface 102. Specifically, depressed portion 12 extends from an end portion of outer surface 102 on the Z1 side to an end portion of outer surface 102 on the Z2 side. The shape, length, and the like of depressed portion 12 are not limited to the above-described example.

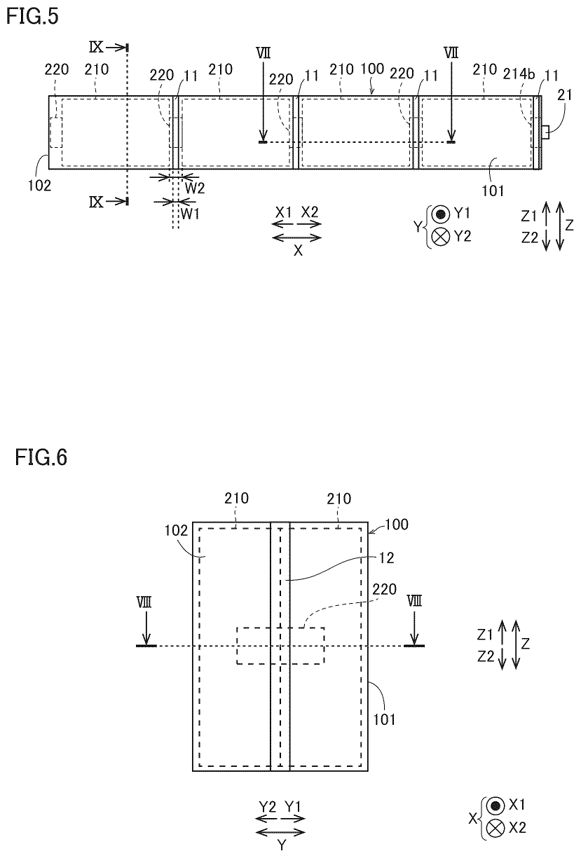

In the present embodiment, the cut portion of case 100 indicated by the depressed portion (11, 12) is a portion corresponding to connection portion 220 (see FIG. 3 for example). The details are described with reference to FIG. 5.

FIG. 5 is a front view of outer surface 101. As illustrated in FIG. 5, each of the plurality of depressed portions 11 is provided in a position overlapping connection portion 220 (protruding portion 214b) in the Y direction. Specifically, each of the three depressed portions 11 on the X1 side among the four depressed portions 11 provided on outer surface 101 is provided in a position overlapping connection portion 220 in the Y direction. Among the four depressed portions 11 provided on outer surface 101, the endmost depressed portion 11 on the X2 side is provided in a position that, in the Y direction, overlaps protruding portion 214b electrically connecting the endmost power storage cell 210 (210A, 210H) on the X2 side and external terminal 21.

Each of the plurality of depressed portions 11 has a width W1 in the X direction. Connection portion 220 that connects power storage cells 210 adjacent to each other in the X direction has a width W2 in the X direction. Width W1 is smaller than width W2. Width W2 is twice the extent to which protruding portion 214b (see FIG. 4) protrudes from through hole 215a (see FIG. 4) in the X direction. Accordingly, width W1 may be smaller than one half of width W2. Thus, each of the plurality of depressed portions 11 is hindered from being provided in a position overlapping power storage cell 210 in the Y direction.

FIG. 6 is a front view of outer surface 102. As illustrated in FIG. 6, depressed portion 12 is provided in a position overlapping connection portion 220 in the X direction. Specifically, depressed portion 12 is provided in the center of outer surface 102 in the Y direction. Thus, depressed portion 12 is provided in a position that, in the X direction, overlaps a portion between the two power storage cells 210 arranged side by side in the Y direction (a contact surface between power storage cells 210).

In the present embodiment, the cut portion of case 100 indicated by depressed portion 11 (12) includes a fragile portion. In other words, the fragile portion is formed in a position corresponding to the cut portion.

Specifically, as illustrated in FIG. 7, a thin portion 11a is formed on side surface 101a by providing depressed portion 11 on outer surface 101. That is, thin portion 11a is a portion of side surface 101a provided on the Y2 side (the inner surface side of case body 10) of depressed portion 11. Thin portion 11a is an example of the “fragile portion” in the present disclosure.

Thin portion 11a has a thickness t1 in the Y direction. Thickness t1 of thin portion 11a is smaller than a thickness t2 of the portion of side surface 101a in the Y direction, where thin portion 11a is not provided. Thickness t1 may be smaller than or equal to one half of thickness t2, for example.

Further, as illustrated in FIG. 8, a thin portion 12a is formed on side surface 102a by providing depressed portion 12 on outer surface 102. Thin portion 12a is a portion of side surface 102a provided on the Y2 side (the inner surface side of case body 10) of depressed portion 12. Thin portion 12a is an example of the “fragile portion” in the present disclosure.

Thin portion 12a has a thickness t11 in the X direction. Thickness t11 of thin portion 12a is smaller than a thickness t12 of the portion of side surface 102a in the X direction, where thin portion 12a is not provided. Thickness t11 may be smaller than or equal to one half of thickness t12, for example.

FIG. 9 is a cross-sectional view along line IX-IX in FIG. 5. Power storage module 200 includes a cover sheet 230. Cover sheet 230 is accommodated in case 100. Case body 10 surrounds the plurality of power storage cells 210 and cover sheet 230.

Cover sheet 230 covers the plurality of power storage cells 210. Specifically, cover sheet 230 covers power storage cells 210 so as to collectively surround the plurality of power storage cells 210. Cover sheet 230 is made of an electrically insulating material (such as a synthetic resin).

The cutting of power storage device 1 includes a first step in which power storage device 1 is cut along depressed portion 11 corresponding to protruding portion 214b (see FIG. 5) that connects power storage cell 210 and external terminal 21, a second step in which power storage device 1 is cut along the three depressed portions 11 corresponding to connection portions 220 after the first step, and a third step in which power storage device 1 is cut along depressed portion 12 after the second step. The order of the cutting steps is not limited to the above-described example.

As described above, in power storage device 1 according to the present embodiment, the outer surface (101, 102) of case 100 is provided with the depressed portion (11, 12) indicating the cut portion of case 100 to be cut when power storage device 1 is disassembled. Thus, power storage device 1 can be cut by using the depressed portion (11, 12) as an indicator. As a result, power storage device 1 can be appropriately cut by cutting power storage device 1 along the depressed portion (11, 12) without identifying an appropriate cutting position of power storage device 1.

In power storage device 1 according to the present embodiment, the cut portion of case 100 indicated by the depressed portion (11, 12) includes a portion corresponding to connection portion 220. Thus, by cutting case 100 along the depressed portion (11, 12), connection portion 220 can be cut and power storage cells 210 can be separated from each other. Accordingly, cutting power storage cell 210 itself can be hindered. As a result, power storage cell 210 can be recycled easily.

Although an example in which the cut portion of case 100 is indicated by the depressed portion (11, 12) is presented in the above-described embodiment, the present disclosure is not limited to this example. The cut portion of the case may be indicated by something other than the depressed portion.

For example, in the example illustrated in FIG. 10, the cut portion of a case 300 is indicated by a line 311 and a mark 312 so as to be visually recognizable. Line 311 is given so as to extend in the Z direction on an outer surface 301 of case 300. The plurality of (three in FIG. 10) marks 312 are given so as to be arranged in the Z direction on outer surface 301. At least one of line 311 and mark 312 may be given on an outer surface of case 300 other than outer surface 301.

Although an example in which both line 311 and mark 312 are given on case 300 is illustrated in FIG. 10, only one of line 311 and mark 312 may be given on case 300. The shape, arrangement, and the like of each of line 311 and mark 312 are not limited to the example illustrated in FIG. 10. Further, line 311 and mark 312 may be given with a pen or the like, or may be given by discoloring metal or the like. Each of line 311 and mark 312 is an example of the “information providing portion” in the present disclosure.

In the example illustrated in FIG. 11, a projecting portion 411, by which the cut portion of a case 400 is indicated so as to be visually recognizable, is formed on an outer surface 401 of case 400. On a side surface 401a where outer surface 401 is provided, a thin portion 411a is formed by providing projecting portion 411 on outer surface 401. Thin portion 411a is a portion of side surface 401a, which is provided on the Y2 side (the inner surface side of case body) of depressed portion 411. Projecting portion 411 may be provided on an outer surface of case 400 other than outer surface 401. Thin portion 411a is an example of the “fragile portion” in the present disclosure. Projecting portion 411 is an example of the “information providing portion” in the present disclosure.

Thin portion 411a has a thickness t21 in the Y direction. Thickness t21 of thin portion 411a is smaller than a thickness t22 of the portion of side surface 401a in the Y direction, where thin portion 411a is not provided. The thin portion is not necessarily required to be formed in the position corresponding to projecting portion 411. In addition, both the depressed portion (11, 12) and projecting portion 411 according to the above-described embodiment may be provided on the outer surface of the case.

Although case 400 is cut at the position where projecting portion 411 is provided in the example illustrated in FIG. 11, the present disclosure is not limited to this example. A portion between the projecting portions provided so as to be adjacent to each other may be cut. This feature may also be applied to the above-described embodiment and each variation.

In addition, in the example illustrated in FIG. 12, a member 511 by which the cut portion of a case 500 is indicated so as to be visually recognizable is attached to an outer surface 501 of case 500. Member 511 may be, for example, a sticker, a tape, or the like. Member 511 may be attached to an outer surface of case 500 other than outer surface 501. Member 511 is an example of the “information providing portion” in the present disclosure.

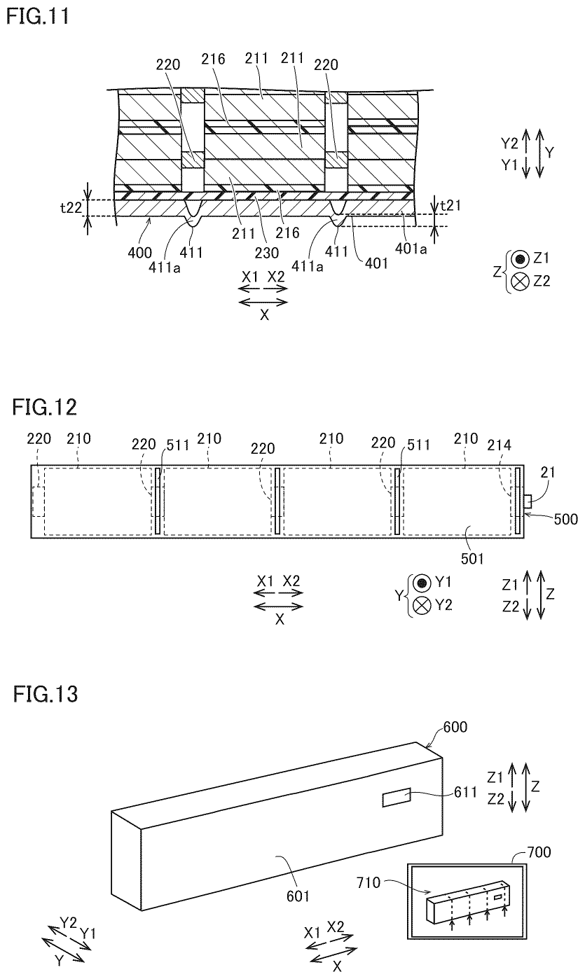

In the example illustrated in FIG. 13, a code 611 is attached to an outer surface 601 of a case 600. Code 611 is, for example, a QR code (registered trademark). As illustrated in FIG. 13, information on the cut portion of case 600 is obtainable from code 611 imaged (read) by a terminal 700 (such as a smartphone, a tablet, or the like). Specifically, code 611 is imaged (read) by terminal 700 and thus the positional information on the cut portion of case 600 is displayed on a screen 710 of terminal 700. The positional information on the cut portion is indicated by an arrow on screen 710. Code 611 may be attached to an outer surface of case 600 other than outer surface 601. Code 611 and terminal 700 are examples of the “information providing portion” and the “information obtaining device” in the present disclosure, respectively.

Although not illustrated, a through hole may be provided instead of depressed portion 11 (12) according to the above-described embodiment. A resin or the like may be injected into the case through the through hole.

Further, a winding key used in opening a can or the like may be provided on the cut portion of the case.

Although an example in which the cut portion of case 100 is the thin portion (11a, 12a) is presented in the above-described embodiment, the present disclosure is not limited to this example. The cut portion may undergo knurling (a process by which fine irregularities or cuts are formed in metal).

Although an example in which the plurality of power storage cells 210 are accommodated in case 100 is presented in the above-described embodiment, the present disclosure is not limited to this example. The number of power storage cells accommodated in the case may be one.

Although an example in which case 100 has a sealed structure is presented in the above-described embodiment, the present disclosure is not limited to this example. Case 100 is not necessarily required to be sealed.

Although an example in which the fragile portion is provided in case 100 by forming the thin portion (11a, 12a) is presented in the above-described embodiment, the present disclosure is not limited to this example. The case is not necessarily required to be provided with the fragile portion.

Although an example in which the depressed portion is provided on each of outer surface 101 and outer surface 102 is presented in the above-described embodiment, the present disclosure is not limited to this example. Only one of outer surface 101 and outer surface 102 may be provided with the depressed portion. Further, the depressed portion may be provided on an outer surface of case 100 other than outer surface 101 and outer surface 102.

The configurations in the embodiments and variations described above may be combined with each other.

Although embodiments of the present disclosure have been described, it should be understood that the herein-disclosed embodiments are presented by way of illustration and example in all respects and are not to be taken by way of limitation. The scope of the present disclosure is defined by the claims and intended to include all changes within the purport and scope equivalent to the claims.

What is claimed is:

1. A power storage device comprising:
a power storage module including at least one power storage cell; and
a case that accommodates the power storage module, wherein
an outer surface of the case is provided with an information providing portion indicating a cut portion of the case to be cut when the power storage device is disassembled.

2. The power storage device according to claim 1, wherein
the at least one power storage cell includes a plurality of power storage cells,
the power storage module includes a connection portion that connects different power storage cells of the plurality of power storage cells to each other, and
the cut portion is a portion corresponding to the connection portion.

3. The power storage device according to claim 1, wherein the case has a sealed structure.

4. The power storage device according to claim 1, wherein the cut portion includes a fragile portion.

5. The power storage device according to claim 1, wherein the information providing portion includes at least one of a line and a mark given on the outer surface of the case to indicate the cut portion so that the cut portion is visually recognizable.

6. The power storage device according to claim 1, wherein the information providing portion includes at least one of a depressed portion and a projecting portion formed on the outer surface of the case to indicate the cut portion so that the cut portion is visually recognizable.

7. The power storage device according to claim 1, wherein the information providing portion includes a member attached to the outer surface of the case to indicate the cut portion so that the cut portion is visually recognizable.

8. The power storage device according to claim 1, wherein the information providing portion includes a code, information on the cut portion being obtainable from the code imaged by an information obtaining device.
